(19) United States
(12) Patent Application Publication
(10) Pub. No.: US 2012/0253954 A1
(43) Pub. Date: Oct. 4, 2012

(54) PAYMENT VERIFICATION SYSTEM

(76) Inventor: Wah Cheong Wong, San Francisco, CA (US)

(21) Appl. No.: 13/405,295

(22) Filed: Feb. 25, 2012

Related U.S. Application Data
(60) Provisional application No. 61/468,220, filed on Mar. 28, 2011.

(51) Int. Cl. G06Q 40/00

(52) U.S. Cl. 705/16; 705/30

(57) ABSTRACT

A device comprising a processor, a display coupled to the processor, a keypad, and a memory. Wherein the memory includes processor-readable instructions operable to receive sales transaction information, present said sales information on the display, receive a verification indication from a customer and store the sales transaction information locally or on a remote system. The sales transaction information may include a running total of sales. Also disclosed is an administration operation wherein an administrator may enter a password or PIN to collect the total sales information and reset the running total. Certain embodiments may provide for customer policing of cash sales and increased reporting of sales transactions to landlords, franchisors, sate and local governments.

### PRIORITY

This application claims the benefit of U.S. provisional patent application 61/468,220 entitled “Payment Verification System” by the same inventor, filed Mar. 28, 2011 which is hereby incorporated by reference as if fully set forth herein.

### BACKGROUND

Business services that rely on a percentage of receipts are often not sufficiently paid when cash is involved in the transaction. This is because cash transactions are often not recorded, whereas electronic transactions such as debit card purchases and credit card transactions are inherently recorded and traceable. This absence of recordation results in underpayments whenever a percentage of sales is used as a basis for a service.

This can most easily be illustrated in the collection of sales taxes where cash transaction are not recorded and there is no reliable way for an auditor to determine the proper amount of sales tax owed to the governing agency. Moreover, a merchant who collects sales tax on a sale and then does not report a cash sale benefits two ways, first they do not pay taxes and second they keep for themselves the collected tax.

Other agencies such as franchisors and leasers often rely on a percentage of sales to determine how the merchant should pay for the franchise or lease. For example, rent may be determined as a percentage of sales revenue. By not recording cash transactions the merchant gains at the expense of these agencies, in this case the landlord.

Accordingly improvements in the recordability of cash transactions would help alleviate these problems.

### SUMMARY

Disclosed herein is a system for recording sales, especially cash sales. In some embodiments a “stand alone” device may be employed where a user enters a transaction amount. Once an amount is entered, a customer verifies the amount by entering a key press or some other affirmative action to verify the transaction. The transaction amount is recorded as part of a running total of transactions. Authorized users may then view the running total and if desired, reset the running total.

In other embodiments a “stand alone” device may be coupled with other devices or processing systems either directly, wirelessly or through other devices or techniques. This has the effect of allowing the stand alone device to provide sales and verification information to other systems for further operation.

In other embodiments a cash register may be employed where a user enters a transaction amount. Once an amount is entered, a customer verifies the amount by entering a key press or some other affirmative action to verify the transaction. The transaction amount is recorded as part of a running total of transactions. This may allow for commercially available cash registers to incorporate some of the functions of a “stand alone” device.

Still other embodiments use networked communications such as cell phones, personal digital assistants (PDAs) and the like, to effect recording cash sales according to methods disclosed herein.

Certain embodiments disclosed herein provide for a means for a customer of a business to police the business by forcing them to record a cash transaction.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

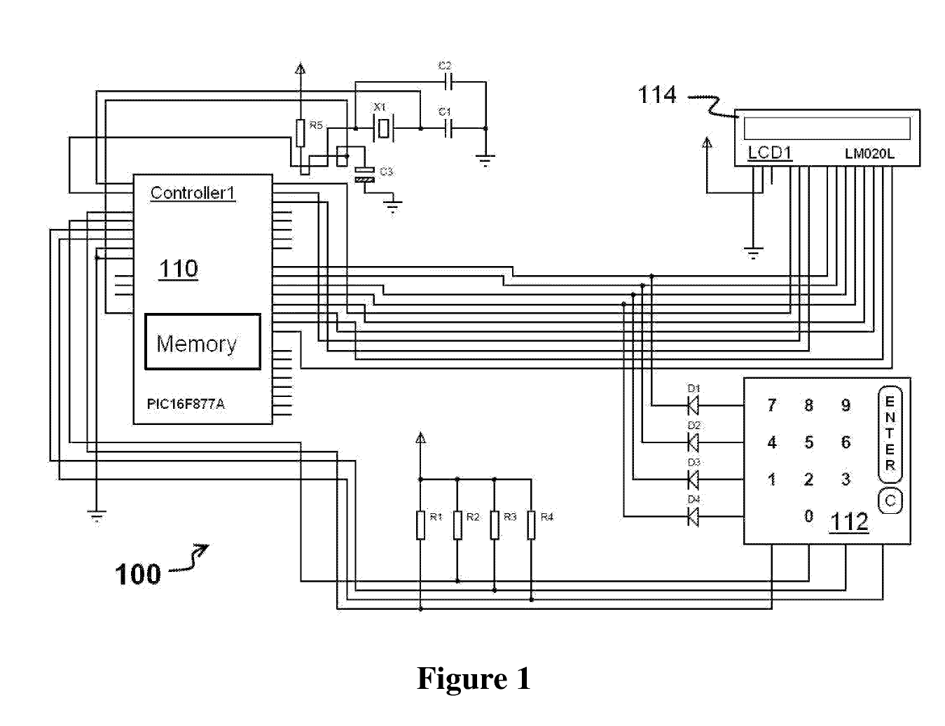

FIG. 1

FIG. 1 shows a simplified schematic diagram of a processing system 100 according to the current disclosure. In FIG. 1 a microprocessor (or controller) 110 is coupled to a keypad 112 and to a display 114. The processor, which may be effectuated with commercially available controllers such as the PIC controllers manufactured by Microchip Technology. These controllers 110 contain display driving circuitry, keypad driving circuitry and various memories to effect operations. Moreover PIC controllers often include A/D convertors, UARTs and other input/output features. The controller 110 is operable to receive an input using the keypad 112 and display the entry on the display 114. Support electronics such as clock circuits, resistors and diodes to support operations are shown.

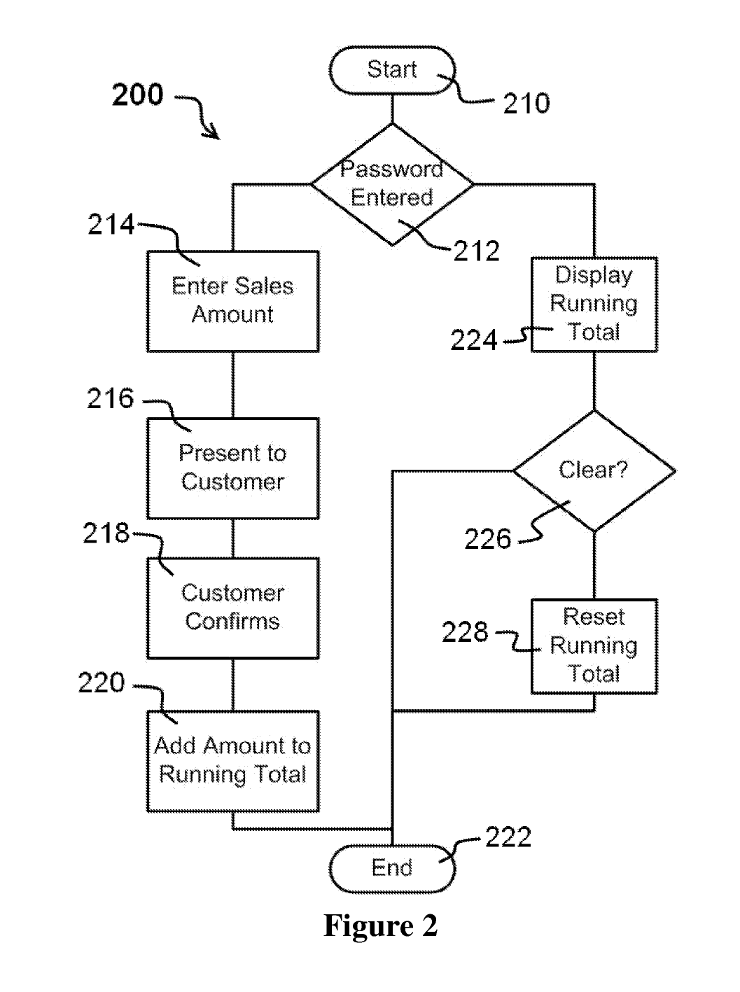

FIG. 2

FIG. 2 shows a method. In FIG. 2 the method begins at a flow label 210. At a step 212 the user may enter a password (or PIN number). If the user does not enter a password, the flow continues to a step 214. At the step 214, a user enters an amount of money representing a sales amount. At a step 216 the amount entered in the step 214 is presented to the customer. At a step 218 the customer confirms the amount and at a step 220, the amount is added to a running total and the flow continues to a flow label 222 indicating the end of the method.

If, at the step 212 a password is entered, then flow continues to a step 224. At the step 224 the running total is displayed. At a step 226 a clear input may be accepted. If a clear input is not accepted flow continues to a flow label 222 indicating the end of the method. If a clear input is accepted, flow continues to a step 228. At the step 228 the running total is reset to zero.

In operation, a sales amount is entered into a programmable device such as the one depicted in FIG. 1 and an amount is entered. The device is presented to a customer who confirms the sales amount and the sales amount is then added to a “running total.” The running total provides a record of the total sales amount for any number of transactions. The motivation for operation may be a legal requirement or contract obligation, whereas the motivation for the customer may be to police the sales activity to make sure taxes are appropriately recorded and paid.

An administrator may have a password which allows them the ability to see the running total and to reset the amount if desired. Accordingly a record of sales transactions is made and cannot be erased without a password. in certain embodiments, the administrator may access the programmable device remotely using conventional communication means.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such features, structure or characteristic in connection with other embodiments whether or not explicitly described. Parts of the description are presented using terminology commonly employed by those of ordinary skill in the art to convey the substance of their work to others of ordinary skill in the art.

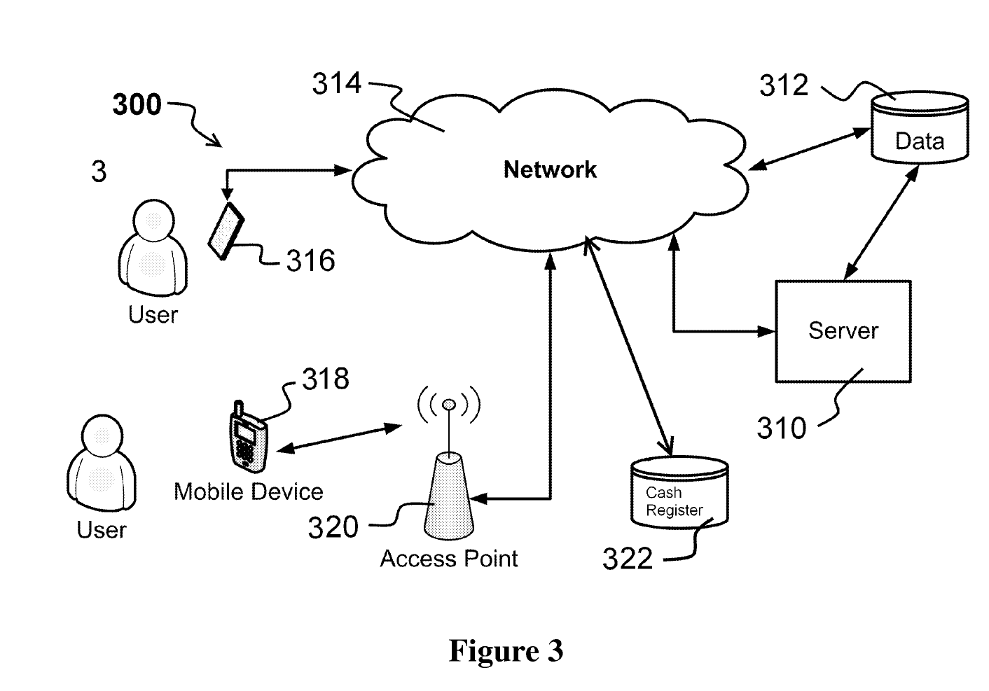

FIG. 3

FIG. 3 shows a functional block diagram of a client server system 300. In some embodiments the system 300 may include some of, or all of the elements depicted in FIG. 3 that may be employed for some embodiments according to the current disclosure. In FIG. 3 a server 310 is coupled to one or more databases 312 and to a network 314. A user accesses the server by a user input device 316 communicably coupled to the network 314. Alternatively the user may access the server 310 through the network 314 by using a smart device such as a telephone or PDA 318. The smart device 318 may connect to the server 310 through an access point 120 coupled to the network 314. Moreover wireless access such as WiFi, Bluetooth and other protocols may be employed to effectuate a similar system.

The server 310 may be coupled to one or more public communication systems (not shown). The coupling may be directly to the servers 310 or optionally through the network 314. The public communication systems include telephony, text messaging, email, conventional mail and the like. The system may also include a connection to a cash register 322 for recording sales.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, a user interface and the like may be employed. These engines may seek and gather information about events from remote data sources. The inventors envision a data storage engine for managing stored data such as legal documents, an information engine for gathering information from various data sources, public and private and a notification engine for implementing public and private communications functions.

### Structured Data

A structured data source such as a spreadsheet, file system, disk operating system (DOS), XML file, database and the like may be used to record information. The techniques and methods described herein may be effectuated using a variety of hardware and other techniques that persist data and any of the ones specifically described herein are by way of example only and are not limiting in any way.

### Additional Operation

A user interface may be employed to allow one or more users to upload to a server information concerning a cash sale. This would include a sales amount and a customer confirmation. Either during or immediately after the upload process, the information may be encrypted, thus providing for an additional level of security beyond the usual data protection schemes used for password protected security.

### Notification

A notification engine may be operable to notify a user (or one associated with a user), of the existence of and amount of a running total and any business associated with that running total. This has the effect of letting a user monitor remotely sales or other transactional operation. Moreover a server may be operable to provide the same or similar information as a web page wherein a user may login to see running totals and the like. The notification may be responsive to the type of transaction. Mobile devices may allow for wireless operation such as verification and reporting through the use of conventional wireless communication protocols such as Bluetooth and WiFi.

Certain embodiments may also include a remote reporting mechanism operable to communicate with a government reporting agency such as a state tax collection department. This may be effectuated by connecting to a server programmed to communicate with the government agency. Upon receipt of the report the government agency may act as an administrator and may perform reset functions.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. A method comprising:
electronically recording a sales amount, said sales amount entered by a first user;
presenting the electronic recorded sales amount to a second user;
receiving a verification indication from the second user;
adding the sales amount to a previously recorded sales amount, and
storing the results of said adding.

2. The method of claim 1 wherein the electronic recording is performed on a mobile device.

3. The method of claim 2 wherein the mobile device is wirelessly coupled to a server, and the storing is at the server.

4. The method of claim 3 further including:
receiving a password from a third user, and
resetting the results of said adding.

5. The method if claim 1 wherein the electronically recording and the presenting are perform on a cash register.

6. A device comprising:
a processor;
a display, said display coupled to said processor;
a keypad, said keypad coupled to said processor;
a memory coupled to said processor, said memory including processor-readable instructions operable to receive sales transaction information, present said sales information on the display, receive a verification indication from a user and store the sales transaction information.

7. The device of claim 6 further including:
an input/output control, said input/output control communicably coupled to said processor and operable to communicate remotely.

8. The device of claim 7 wherein the communication is wireless.

9. The device of claim 6 wherein the storing the sales transaction information is on a server.

10. The device of claim 6 wherein the memory further includes processor-readable instructions operable to cause the device to accept a password and reset the stored sales transaction information.

11. The device of claim 6 wherein the sales transaction information includes a cumulative total of present and prior sales.

12. One or more processor-readable storage devices having processor-readable code embodied on said processor-readable storage devices, said processor readable code including instructions for programming one or more processors to:
electronically record a sales amount, said sales amount entered by a first user;
present the electronic recorded sales amount to a second user;
record a verification indication from the second user;
add the sales amount to a previously recorded sales amount, and
store the results of said adding.

13. The storage device of claim 12 wherein the electronic recording is performed on a mobile device.

14. The storage device of claim 13 wherein the mobile device is wirelessly coupled to a server, and the storing is at the server.

15. The storage device of claim 12 wherein the instructions further include:
receiving a password from a third user, and
resetting the results of said adding.

16. The storage device of claim 12 wherein the electronically recording and the presenting are performed on a cash register.
